(19) United States
(12) Patent Application Publication
(10) Pub. No.: US 2013/0066458 A1
(43) Pub. Date: Mar. 14, 2013

(54) SYSTEMS AND METHODS FOR APPROPRIATELY ALLOWING ORCHIDS TO WEATHER OUTDOOR ENVIRONMENTS DURING TRANSPORTATION THEREOF

(71) Applicant: Yat Wai Edwin Kwong, Causeway Bay (HK)

(72) Inventor: Yat Wai Edwin Kwong, Causeway Bay (HK)

(21) Appl. No.: 13/229,585

(22) Filed: Sep. 9, 2011

(51) Int. Cl. G06F 7/00

(52) U.S. Cl. 700/213

(57) ABSTRACT

An orchid caring system for properly enabling orchids to weather outdoor environments during transportation thereof is provided. The system comprises a plant holder that is configured to be tilted at different angles in order to receive optimal weathering conditions, a vehicle containing the plant holder, a sun blocker associated with the holder, a rain blocker associated with the holder, a sunlight detector associated with the holder, a rain detector associated with the holder, a location detecting device associated with the plant holder, a timer associated with the holder, a computing server providing location-based weather information to the plant holder, a processor associated with the holder, and a device containing memory associated with the holder. The memory causes the processor to execute a method for adjusting the removing/applying of the sun blocker and rain blocker, as well as the tilt direction & angle of the plant holder.

### FIELD OF THE INVENTION

This invention is generally related to systematically caring for plants. More specifically, this invention relates to a plant transporting system which uses real-time weather information to create the most ideal growing environment for the plants being transported.

### BACKGROUND OF THE INVENTION

According to many studies, orchids are plants that require much attention from their owners. For example, an orchid needs to be watered occasionally, but should not be watered too frequently. If overwatered, the roots of the orchid become saturated and the flower blossom negatively affected. At the same time, an orchid without sufficient watering becomes dried up. Thus, a plant owner should be careful in watering their plants. According to many studies, an orchid should receive water once a week. The water received by the plant should not be stagnant in the plant container. Ideally, rain water, if available, can provide natural minerals and nutrients to the orchid. Therefore, there is a need to provide a mechanism to control how much rain water is administered to orchids during varying weather conditions. Similarly, sunlight is vital to the growth of many plants and to orchids in particular. Generally, an orchid can receive sunlight directly, but continual sunlight exposure to the orchid can harm the plant, especially within a strong UV environment. An orchid should receive sunlight for at most, 5 hours a day. Many orchids get sun damaged after receiving excessive sunlight. Therefore, it would help orchids to grow in a tame environment, where sunlight is properly controlled. An additional challenge presented to orchid harvesters is that high grade orchids often require transportation from one location to another. The transportation duration may span anywhere from a couple of hours to a few days. There is therefore, a need to mobilize orchids while providing sufficient care to them, in terms of watering and sunlight.

### SUMMARY OF THE INVENTION

According to embodiments of the invention, an orchid caring system for properly enabling orchids to weather outdoor environments during transportation thereof is provided. The system comprises a plant holder that is configured to be tilted at different angles in order to receive optimal weathering conditions, a vehicle containing the plant holder, a sun blocker associated with the holder, a rain blocker associated with the holder, a sunlight detector associated with the holder, a rain detector associated with the holder, a location detecting device associated with the plant holder, a timer associated with the holder, a computing server providing location-based weather information to the plant holder, a processor associated with the holder, and a device containing memory associated with the holder.

The memory stores instructions that cause the processor to execute a method. The method comprises the following steps. The first step involves determining, based on the location detecting device, a location of the plant holder. Next, receiving, from the computing server, weather information with respect to the location of the plant holder, wherein the weather information includes rain information and sunlight information.

The method proceeds by adjusting the rain blocker accordingly based on the rain information received such that the rain blocker is removed if rain is detected at the location. Then, adjusting the sun blocker based on sunlight information at the location in order for the plant to receive a controlled amount of sunlight. Next, the plant holder is tilted towards the direction of sunlight based on the received sunlight information. Finally, the method ceases with the step of further adjusting the tilt direction of the plant holder based on directional changes of the moving vehicle such that the plant holder is always tilted towards the direction of sunlight

In another embodiment, the method commences with the step of determining, based on the location detecting device, a location of the plant holder. Then, receiving, from the computing server, weather information with respect to the location of the plant holder. The weather information may include rain information and/or sunlight information. The next step involves adjusting the rain blocker accordingly based on the rain information received. Thus, the rain blocker will be removed if rain is detected at the location of the plant holder. Similarly, the sun blocker is then adjusted based on sunlight information at the location of the plant holder.

If it is determined that the plant holder has not received sunlight for a duration exceeding a pre-determined allowed length of time as recorded by the timer, then the following actions are taken: 1) The sun blocker is removed in order for the plant to receive sunlight; 2) The plant holder is tilted in a direction towards sunlight based on the received sunlight information; 3) The timer records a duration of time during which the plant holder receives sunlight; and 4) the tilt direction of the plant holder is further adjusted based on directional changes of the moving vehicle such that the plant holder is always tilted towards the direction of sunlight. Finally, if it is determined that the plant holder has received an excessive amount. If so, the sun blocker is applied in order to prevent the plant from further receiving sunlight.

In yet another embodiment, the method commences with the step of determining, based on the location detecting device, a location of the plant holder. Then, receiving, from the computing server, weather information with respect to the location of the plant holder. The weather information may include rain information and/or sunlight information.

If the weather information indicates that it is raining at the location of the plant holder, and if the plant holder has not received rain water for a duration exceeding a pre-determined allowed length of time then the following actions are taken: 1) removing the rain blocker in order for the plant to receive rain water; and 2) recording, based on the timer, a duration during which the plant holder has received rain water. If the plant holder has received an excessive amount of rain water as determined by the timer, then the rain blocker is applied to prevent the plant from further receiving rain water.

If the plant holder has not received sunlight for a duration exceeding a pre-determined allowed length of a time then the following actions are taken: 1) removing the sun blocker in order for the plant to receive sunlight; 2) tilting the plant holder towards the direction of sunlight based on the received sunlight information; 3) recording, based on the timer, a duration during which the plant holder receives sunlight; and 4) further adjusting the tilt direction of the plant holder based on directional changes of the moving vehicle such that the plant holder is always tilted towards the direction of sunlight. Finally, the method ceases by determining if the plant holder has received the excessive amount of sunlight as determined by the timer. If so, applying the sun blocker to prevent the plant from further receiving sunlight.

In still another embodiment, the method commences with the step of determining, based on the location detecting device, a location of the plant holder. Then, receiving, from the computing server, weather information with respect to the location of the plant holder. The weather information may include rain information and/or sunlight information.

If the weather information indicates that it is raining at the location of the plant holder, then the rain blocker is removed in order for the plant to receive rain water. If the plant holder has not received rain water for a duration exceeding a pre-determined allowed length of time, then the rain blocker is removed in order for the plant holder to receive rain water, and the timer records the duration of time during which the plant holder receives rain water. If the plant holder has received rain water for a duration exceeding a pre-determined allowed length of time, then the rain blocker is applied to prevent the plant from further receiving rain water.

if the plant holder has not received sunlight for a duration exceeding a pre-determined allowed length of time, then the following actions are taken: 1) removing the sun blocker in order for the plant to receive sunlight; 2) tilting the plant holder towards the direction of sunlight based on the received sunlight information; 3) recording, based on the timer, a duration during which the plant holder receives sunlight; and 4) further adjusting the tilt direction of the plant holder based on directional changes of the vehicle such that the plant holder is always tilted towards the direction of sunlight. If the plant holder has received the excessive amount of sunlight as determined by the timer, then the sun blocker is applied to prevent the plant from further receiving sunlight.

Should the location of the plant holder fail to be detected by the location detecting device, then it is determined by the sunlight detector whether there is sunlight at the location of the plant. If the plant holder has not received the excessive amount of sunlight as determined by the timer, then the following actions are taken: 1) removing the sun blocker in order for the plant to receive sunlight; 2) tilting the plant holder towards the direction of sunlight based on the received sunlight information; 3) recording, based on the timer, a duration during which the plant holder receives sunlight; and 4) further adjusting the tilt direction of the plant holder based on directional changes of the vehicle such that the plant holder is always tilted towards the direction of sunlight. Finally, the method commences by determining if the plant holder has received the excessive amount of sunlight. If so, the sun blocker is applied to prevent the plant from further receiving sunlight.

In accordance with these and other objects which will become apparent hereinafter, the invention will now be described with particular reference to the drawing.

### BRIEF DESCRIPTION OF THE DRAWINGS

FIG. 1 illustrates an exemplary system for weathering varying outdoor environmental conditions.

### DETAILED DESCRIPTION

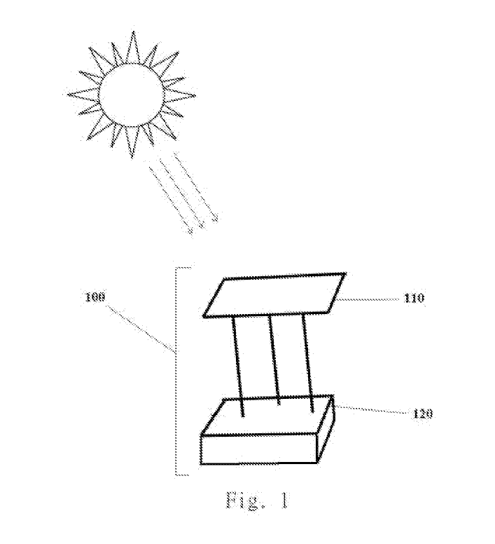

Referring now to the figures, an orchid caring system 100 is provided for appropriately allowing orchids to weather outdoor environments during transportation thereof. In FIG. 1, such a system 100 is shown, comprising a plant holder for holding a plant 120, including an orchid, wherein the holder is configured to be tilted at different angles in order to receive exposure to optimal weather conditions. Also provided are a vehicle containing the plant holder 120, a sun blocker 110 associated with the holder; a rain blocker associated with the holder, a sunlight detector associated with the holder, a rain detector associated with the holder, a location detecting device associated with the plant holder, a timer associated with the holder, a computing server providing information to the plant holder based on the holders location, a processor associated with the holder, and a device containing memory associated with the holder.

The memory stores instructions that cause the processor to execute a method. The method comprises the following steps: First, it is determined, based on the location detecting device, a location of the plant holder 120. The location detecting device may be a Global Positioning System (“GPS”) receiver. The second step involves receiving, from the computing server, the weather information with respect to the location of the plant holder, wherein the weather information includes rain information and sunlight information. This step may be carried out via the internet whereby a third party weather provider may post weather conditions searchable by geographical area. Next, if the weather information indicates that it is raining at the location of the plant holder, the rain blocker is removed in order for the plant to receive rain water; and if the weather information indicates that there is sunlight at the location of the plant: the sun blocker is removed in order for the plant to receive sunlight. Next, in order to receive an optimal amount of sunlight, the plant holder is tilted in a direction towards sunlight based on the sunlight information; and if/when the moving vehicle changes its direction, the plant holder is continuously tilted towards the sunlight in order to compensate for the vehicles changes in direction. This may be carried out using a gyroscopic or hydraulic mechanism that is controlled by the computing device.

In one embodiment, an orchid caring system 100 is provided for appropriately allowing orchids to weather outdoor environments during transportation of the orchids. The system comprises a plant holder 120 for holding a plant, including an orchid, wherein the holder is configured to be tilted at different angles in order to receive optimal weather conditions. Also provided are a moving vehicle containing the plant holder, a sun blocker 110 associated with the holder, a rain blocker associated with the holder, a sunlight detector associated with the holder, a rain detector associated with the holder, a location detecting device associated with the plant holder, a timer associated with the holder, a computing server providing weather information to the plant holder based on the holders location, a processor associated with the holder, and a device containing memory associated with the holder. The memory comprising instructions that cause the processor to execute a method.

The method comprises the following steps: The first step involves determining, based on the location detecting device, a location of the plant holder 120, then receiving, from the computing server, weather information with respect to the location of the plant holder, wherein the weather information includes rain information and sunlight information. If the weather information indicates that it is raining at the location of the plant holder, the rain blocker is removed in order for the plant to receive rain water. Next, it is determined from weather information if there is sunlight at the location of the plant. If the plant holder has not received sunlight for a duration exceeding a pre-determined allowed length of time the sun blocker 110 is removed in order for the plant to receive sunlight. Furthermore, in order to receive an optimal amount of sunlight, the plant holder is tilted in a direction towards sunlight based on the sunlight information. The method proceeds by recording, based on the timer, a duration during which the plant holder has received sunlight. Next, if the moving vehicle changes direction, the plant holder is tilted in another direction towards the sunlight. Finally, if the plant holder has received an excessive amount of sunlight, the sun blocker is applied to prevent the plant from further receiving sunlight.

In yet another embodiment, an orchid caring system 100 is provided for appropriately allowing orchids to weather outdoor environments during transportation of the orchids. The system comprises a plant holder 120 configured to be tilted at different angles in order to be exposed to optimal weather conditions. The systems other components are a vehicle containing the plant holder, a sun blocker 110 associated with the holder, a rain blocker associated with the holder, a sunlight detector associated with the holder, a rain detector associated with the holder, a location detecting device associated with the holder, a timer associated with the holder, a computing server providing location-based weather information to the holder, a processor associated with the holder; and a device containing memory associated with the holder. The memory stored on the device comprises instructions that cause the processor to execute a method.

The method comprises the following steps: The first step involves determining, based on the location detecting device, a location of the plant holder 120, and receiving, from the computing server, weather information with respect to the location of the plant holder. The weather information may be, but is not limited to rain information and sunlight information. If the weather information indicates that it is raining at the location of the plant holder, the rain blocker is removed in order for the plant to receive rain water. If the plant holder has not received rain water for a duration of time exceeding a pre-determined allowed length, then the rain blocker is removed in order for the plant to receive rain water. The method proceeds by recording, based on the timer, a duration of time during which the plant holder has received rain water. If the plant holder has received an excessive amount of rain water, the rain blocker is applied to prevent the plant from further receiving rain water. If the weather information indicates that there is sunlight at the location of the plant and if the plant holder has not received sunlight for a duration greater than a pre-determined allowed length of time, then the sun blocker 110 is removed in order for the plant to receive sunlight. In order to receive an optimal amount of sunlight, the plant holder may be tilted in a direction towards sunlight based on the sunlight information. The method proceeds by recording, based on the timer, a duration during which the plant holder has received sunlight. Next, if the moving vehicle changes direction, the plant holder is tilted in another direction towards the sunlight. Finally, if the plant holder has received an excessive amount of sunlight, the sun blocker is applied to prevent the plant from further receiving sunlight.

In a further embodiment, an orchid caring system 100 for appropriately allowing orchids to weather outdoor environments during transportation of the orchids is provided. The systems components include a plant holder 120 configured to be tilted in different angles in order to receive optimal weather conditions, a vehicle containing the plant holder, a sun blocker 110 associated with the holder, a rain blocker associated with the holder, a sunlight detector associated with the holder, a rain detector associated with the holder, a location detecting device associated with the plant holder, a timer associated with the holder, a computing server providing location-based weather information to the plant holder, a processor associated with the holder, and a device containing memory associated with the holder. The memory comprises instructions that cause the processor to execute a method which proceeds along the following steps.

The method begins by determining, based on the location detecting device, a location of the plant holder 120. If the location of the plant holder is detected by the location detecting device, then location-based weather information is received. The weather information may include rain information and sunlight information. If the weather information indicates that it is raining at the location of the plant holder, the rain blocker is removed in order for the plant to receive rain water. If the plant holder has not received rain water for a duration exceeding a pre-determined allowed length of a given period, then the rain blocker is removed in order for the plant to receive rain water. Contemporaneously, a timer begins recording the duration of time during which the plant receives rain water. If the plant holder has received an excessive amount of rain water, the sun blocker is applied to prevent the plant from further receiving rain water. If the weather information indicates that there is sunlight at the location of the plant, then the sun blocker 110 is removed provided that the plant holder has not received sunlight for a duration exceeding a pre-determined allowed length of a given period. Furthermore, in order to receive an optimal amount of sunlight, the plant holder is tilted in a direction towards sunlight based on the provided sunlight information. Contemporaneously, a timer begins recording the duration of time during which the plant receives sunlight.

Proceeding with the method, if the moving vehicle changes direction, the plant holder 120 is tilted in another direction to maintain direct exposure to the sunlight. If it is determined that the plant holder has received the excessive amount of sunlight, the sun blocker 110 is applied to prevent the plant from further receiving sunlight.

In the event that the location of the plant holder 120 fails to be detected by the location detecting device, then the presence of sunlight is detected by the sunlight detector. If the plant holder has not received sunlight for a duration exceeding a pre-determined allowed length of a given period, then the sun blocker 110 is removed in order for the plant to receive sunlight. In order to receive an optimal amount of sunlight, the plant holder is tilted towards the direction of sunlight, as indicated by the sunlight detector. Contemporaneously, a timer begins recording the duration of time during which the plant receives sunlight. Furthermore, if the moving vehicle changes direction, the plant holder is tilted in another direction to maintain direct exposure to the sunlight. If it is determined that the plant holder has received the excessive amount of sunlight, the sun blocker is applied to prevent the plant from further receiving sunlight.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. An orchid caring system for appropriately allowing orchids to weather outdoor environments during transportation of the orchids, comprising:
a plant holder for holding a plant, including an orchid, wherein the holder is configured to be tilted at different angles in order to receive optimal weather conditions;
a vehicle containing the holder;
a sun blocker associated with the holder;
a rain blocker associated with the holder;
a sunlight detector associated with the holder;
a rain detector associated with the holder;
a location detecting device associated with the holder;
a timer associated with the holder;
a computing server providing information to the plant holder, wherein the information includes weather information with respect to a location;
a processor associated with the holder; and
a device containing memory associated with the holder, the memory comprising instructions that causes the processor to execute a method.

2. The system of claim 1, wherein the method comprises the following steps:
determining, based on the location detecting device, a location of the plant holder;
receiving, from the computing server, weather information with respect to the location of the plant holder, said weather information including rain information and sunlight information;
adjusting the rain blocker accordingly based on the rain information received such that the rain blocker is removed if rain is detected at the location;
adjusting the sun blocker based on sunlight information at the location in order for the plant to receive a controlled amount of sunlight;
tilting the plant holder towards the direction of sunlight based on the received sunlight information; and
further adjusting the tilt direction of the plant holder based on directional changes of the vehicle such that the plant holder is always tilted towards the direction of sunlight.

3. The system of claim 1, wherein the method comprises:
determining, based on the location detecting device, a location of the plant holder;
receiving, from the computing server, weather information with respect to the location of the plant holder, wherein the weather information includes rain information and sunlight information;
adjusting the rain blocker accordingly based on the rain information received such that the rain blocker is removed if rain is detected at the location of the plant holder;
adjusting the sun blocker based on sunlight information at the location of the plant holder;
if the plant holder has not received sunlight for a duration exceeding a pre-determined allowed length of time as recorded by the timer:
removing the sun blocker in order for the plant to receive sunlight;
tilting the plant holder towards the direction of sunlight based on the received sunlight information;
recording, based on the timer, a duration during which the plant holder receives sunlight; and
further adjusting the tilt direction of the plant holder based on directional changes of the vehicle such that the plant holder is always tilted towards the direction of sunlight; and
if the plant holder has received the excessive amount of sunlight as determined by the timer:
applying the sun blocker to prevent the plant from further receiving sunlight.

4. The system of claim 1, wherein the method comprises the following steps:
determining, based on the location detecting device, a location of the plant holder;
receiving, from the computing server, weather information with respect to the location of the plant holder, wherein the weather information includes rain information and sunlight information;
if the weather information indicates that it is raining at the location of the plant holder, and if the plant holder has not received rain water for a duration exceeding a pre-determined allowed length of time:
removing the rain blocker in order for the plant to receive rain water; and
recording, based on the timer, a duration during which the plant holder has received rain water; and
if the plant holder has received the excessive amount of rain water as determined by the timer:
applying the rain blocker to prevent the plant from further receiving rain water;
if the plant holder has not received sunlight for a duration exceeding a pre-determined allowed length of a time:
removing the sun blocker in order for the plant to receive sunlight;
tilting the plant holder towards the direction of sunlight based on the received sunlight information;
recording, based on the timer, a duration during which the plant holder receives sunlight; and
further adjusting the tilt direction of the plant holder based on directional changes of the moving vehicle such that the plant holder is always tilted towards the direction of sunlight; and
if the plant holder has received the excessive amount of sunlight as determined by the timer, applying the sun blocker to prevent the plant from further receiving sunlight.

5. The system of claim 1, wherein the method comprises the following steps:
determining, based on the location detecting device, a location of the plant holder;
if the location of the plant holder is detected by the location detecting device:
receiving, from the computing server, the weather information with respect to the location of the plant holder, wherein the weather information includes rain information and sunlight information;
if the weather information indicates that it is raining at the location of the plant holder:
removing the rain blocker in order for the plant to receive rain water;
if the plant holder has not received rain water for a duration exceeding a pre-determined allowed length of time:
removing the rain blocker in order for the plant to receive rain water and, recording, based on the timer, a duration during which the plant holder receives rain water;
if the plant holder has received rain water for a duration exceeding a pre-determined allowed length of time:
applying the rain blocker to prevent the plant from further receiving rain water;
if the plant holder has not received sunlight for a duration exceeding a pre-determined allowed length of time:
removing the sun blocker in order for the plant to receive sunlight;
tilting the plant holder towards the direction of sunlight based on the received sunlight information;
recording, based on the timer, a duration during which the plant holder receives sunlight; and
further adjusting the tilt direction of the plant holder based on directional changes of the moving vehicle such that the plant holder is always tilted towards the direction of sunlight;
if the plant holder has received the excessive amount of sunlight as determined by the timer:
applying the sun blocker to prevent the plant from further receiving sunlight;
if the location of the plant holder fails to be detected by the location detecting device:
determining, by the sunlight detector, whether there is sunlight at the location of the plant;
if the plant holder has not received the excessive amount of sunlight as determined by the timer:
removing the sun blocker in order for the plant to receive sunlight;
tilting the plant holder towards the direction of sunlight based on the received sunlight information;
recording, based on the timer, a duration during which the plant holder receives sunlight; and
further adjusting the tilt direction of the plant holder based on directional changes of the moving vehicle such that the plant holder is always tilted towards the direction of sunlight; and
if the plant holder has received the excessive amount of sunlight:
applying the sun blocker to prevent the plant from further receiving sunlight.
